(19) United States
(12) Patent Application Publication
(10) Pub. No.: US 2007/0226804 A1
(43) Pub. Date: Sep. 27, 2007

(54) METHOD AND SYSTEM FOR PREVENTING AN UNAUTHORIZED MESSAGE

(76) Inventors: Somkiran, Ranchi (IN); Bansriyar Animesh, Ranchi (IN)

Correspondence Address: Global IP Services, PLLC, 198 F, 27th Cross, 3rd Block Jayanagar, Bangalore- 560011, Karnataka, omitted

(21) Appl. No.: 11/617,749

(22) Filed: Dec. 29, 2006

(30) Foreign Application Priority Data
Mar. 22, 2006 (IN) 239/KOL/2006

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

The present invention discloses a method and system for preventing unauthorized messages. The method comprises determining if a message is composed manually or by an automated agent. Further an identifier, inserted within the message in response to determining if the message is composed manually or by an automated agent r validates the veracity of the message. The message is validated by a central device 110 before being received in the inbox of the user at the receiving device 105.

This application claims priority under 35 USC [symbol] 119(e)(1) of Application No. IN 239/KOL/2006, Filed on 22 Mar. 2006

### FIELD OF THE INVENTION

The invention relates generally to a messaging system and specifically, to a method and system for preventing an unauthorized message.

### BACKGROUND OF THE INVENTION

Unsolicited, unauthorized, irrelevant, or undesired bulk messages are called Spam. Spam consumes more network bandwidth besides being a nuisance. Further, malicious messages containing computer viruses, Trojans and worms can also be transmitted as Spam. Different techniques are currently being followed to control the spread of spam on the Internet.

Anti-Spam software utilizes various filters using memory-processing technology to control the spread of spam on the Internet. Some of common filters such as rule based filters, Bayesian filters and collaborative filters are prevalent in the art. However, filters are not fullproof as human beings with malicious intentions can always find ways of the circumventing the filters. Usage of filters also leads to problems such as clogging of bandwidth, scalability issues, and increase in utilization of resources and manpower. Some corporations charge for the email services, which has to some extent been successful in the control of spam and other unauthorized messages. However, this too faces a lot of resistance by people when other free alternatives are possible.

U.S. Pat. No. 6,199,102 B1, titled “Method and system for filtering electronic messages”, discloses an approach to filter spam messages by providing a question to an unknown message sender. In U.S. patent document US20030204569A1, titled “method and apparatus for filtering e-mail infected with a previously unidentified computer virus”, the incoming mails are analyzed to identify potentially infected mails. Reverse turing test is applied to the source of the infected mails. In the above approaches, no control measure was taken to prevent the spread of the spam at the transmission point itself. Further, U.S. patent No. US20030220978A1, titled “System and method for message sender validation”, discloses a method to verify an e-mail sender by a challenge message when the sender is not included in a white list. Message delivery is postponed till a proper response received to the provided challenge message. U.S. patent No. US20040236838A1, titled “method and code for authenticating electronic messages”, provides an approach by which a message identifier is generated for a sender identified on a list of senders.

There exists a need for a method to effectively prevent spam at the source without the need for tedious maintenance of white list or other list to verify the message sender.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram of a system for preventing an unauthorized message, in accordance with an embodiment of the invention.

FIG. 2 is a block diagram of a sending device, in accordance with an embodiment of the invention.

FIG. 3 is a flow diagram of a method for authenticating a message sender, in accordance with an embodiment of the invention.

FIG. 4 is a flow diagram of a method for preventing an unauthorized message, in accordance with an embodiment of the invention.

FIG. 5 is a block diagram of a receiving device, in accordance with an embodiment of the invention.

FIG. 6 is a flow diagram of a method for preventing an unauthorized message, in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to preventing an unauthorized message. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system to prevent unauthorized messages described herein. The non-processor circuits may include, but are not limited to, a radio receiver, a radio transmitter, signal drivers, clock circuits, power source circuits, and user input devices. As such, these functions may be interpreted as steps of a method to prevent unauthorized messages. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

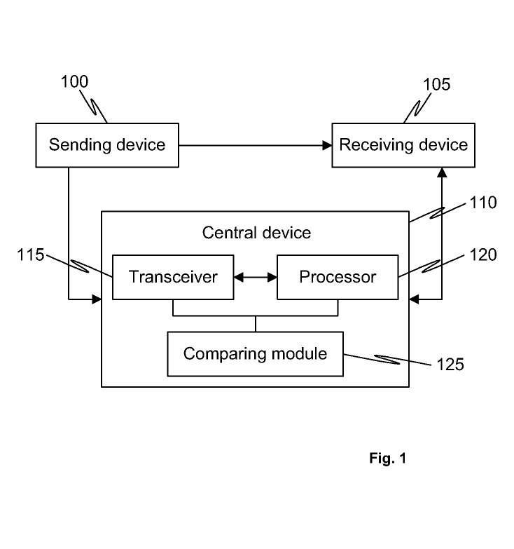

Turning now to FIG. 1 is a block diagram of a system for preventing an unauthorized message, in accordance with an embodiment of the invention. The system comprises a sending device 100, a receiving device 105, and a central device 110 which are in communication with each other through a communications network, for example the Internet. The method of communication can be either a wired or wireless form of communication. Examples of sending devices 100 and the receiving devices 105 may include, but not limited to laptops, personal digital assistants (PDA), personal computers, and mobile devices. As per one embodiment, the central device can be a central server. The central device comprises a transceiver 115, a processor 120, and a comparing module 125. The transceiver 115 is adaptively coupled with a processor 120. The comparing module 125 resides on the central device and is in communication with the transceiver 115 and the processor 120. The functions of each entity disclosed above have been discussed in detail below. Those skilled in the art shall realize that there can be any number of sending, receiving and central devices in the communications network and the depiction shown in FIG. 1 is only for exemplary purposes.

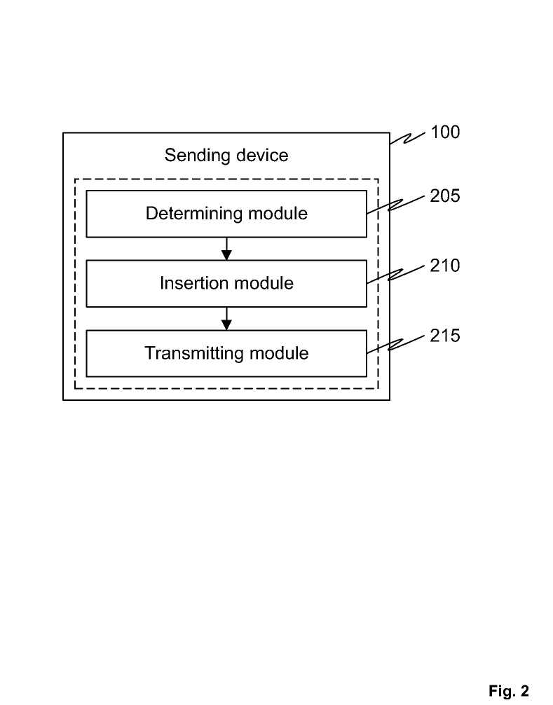

FIG. 2 illustrates a block diagram of a sending device 100, in accordance with an embodiment of the invention. The sending device 100 comprises a determining module 205, an insertion module 210, and a transmitting module 215. The sending device 100 may comprise an e-mail application, for example, Microsoft Outlook or Eudora, that may be used in conjunction with the invention to prevent unauthorized messages being sent using the e-mail application applications. In one embodiment of the invention, the determining module 205, the insertion module 210, and the transmitting module 215 are integrated within a single module such as a software module. As stated earlier, a sending device can be one of a laptop, personal digital assistants (PDA), personal computer and mobile devices.

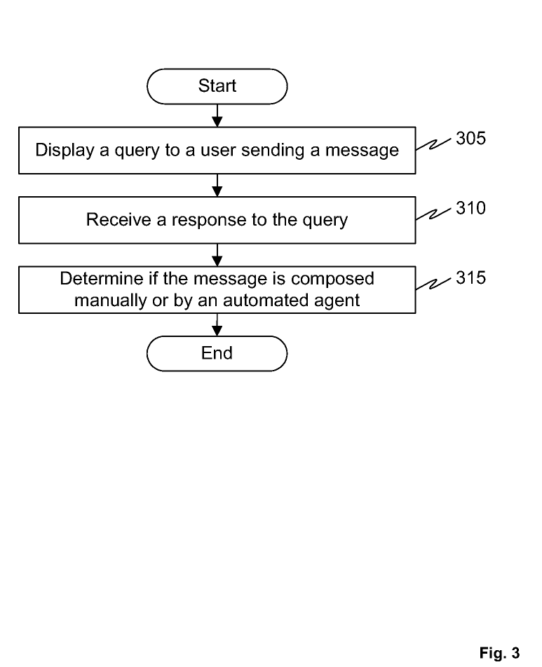

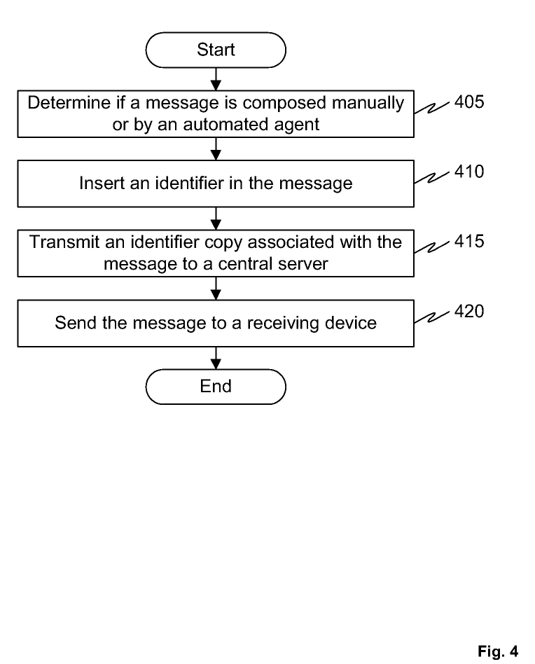

Turning now to FIG. 3 and FIG. 4, FIG. 3 is a flow diagram of a method for authenticating a message sender to prevent dissemination of unauthorized messages, in accordance with an embodiment of the invention. At step 305, the determining module 205 displays a query to a user sending a message from the sending device 100. The message is at least one of an electronic mail, an audio file, a video file, an image file and a multimedia message. The query can be a question framed in a manner that can be answered only by a human being with a reasonable amount of intelligence. For example, the Completely Automated Public Turing Test to Tell Computers and Humans Apart (CAPTCHA) project where a distorted image of a text is shown to a user and the user is required to replicate the text in the image. Such queries require human intelligence. The CAPTCHA is particularly useful in such situations to avoid automated messages, for example Spam being generated. However, those skilled in the art shall appreciate that the CAPTCHA project is an exemplary embodiment and other methodologies that can determine whether the user is a human or a computer can also be used and are within the scope of the present invention.

Once the user has provided a response to the displayed query, step 310, the determining module 205 validates the response and determines whether the message has been composed manually or by an automated agent, step 315. Once the determining module 205 verifies that the message is generated by a human and not automated, step 405, the insertion module 210 inserts an identifier in the message, step 410. The identifier acts like a legitimate stamp to indicate that the message has been generated by a human and not by a machine or robot. Inserting the identifier provides an additional level of security at the receiving device to determine the veracity of the message and assists in discriminating useful messages from the undesired or unauthorized messages. The identifier can be, for example, a 64 bit unique numerical number that may be embedded within the message. The identifier is generated by a specific algorithm. Each message shall have a unique identifier. Those skilled in the art shall realize that the identifier can be any unique identification for the message and is not necessarily limited to numerical identifiers. For example, public-private key encryption techniques may also be employed to validate the veracity of the message at the receiving device 105.

As per an embodiment of the present invention, an identifier copy associated with the message can also be sent to a central server 110 by the transmitting module 215, step 415. The identifier copy is substantially similar to the identifier embedded within each message. The central server 110 shall be responsible to receive the identifier copy and store the identifier copy for future validations. In one embodiment of the invention, the transceiver 115 at the central server 110 receives the identifier copy from the transmitting module 215 of the sending device 100. Once the identifier has been inserted within the message, the message is sent to the receiving device 105 via the transmitting module 215, step 420. Pursuant to an alternate embodiment, only messages inserted with identifiers may be permitted to pass through for transmission. Messages without the identifiers are discarded and prevented from being transmitted. This helps in prevention of spam as well as spreading of viruses.

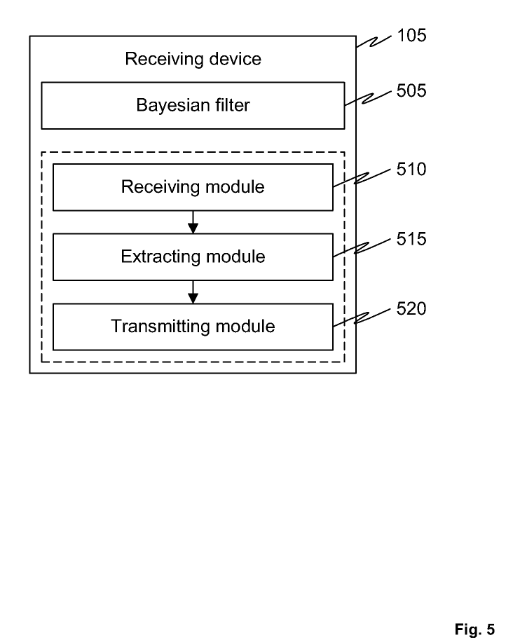

Turning now to FIG. 5 is a block diagram of a receiving device 105, in accordance with an embodiment of the invention. The receiving device 105 comprises a receiving module 510, an extracting module 515, and a transmitting module 520. In one embodiment of the invention, the receiving module 510, the extracting module 515, and the transmitting module 520 are adaptively coupled to each other and integrated within a single module. The receiving device 105 can also comprise a filter, for example a Bayesian filter 505, for filtering messages based on predetermined conditions. The predetermined conditions can be profane words, abusive terms and user defined terms, which shall be used to determine unauthorized messages. As stated earlier, the receiving device 105 can be one of a laptop, personal digital assistants (PDA), personal computer and mobile devices.

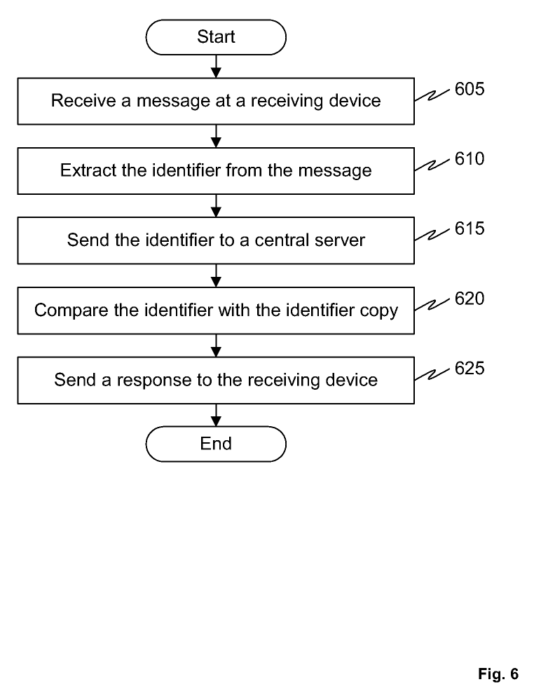

FIG. 6 is a flow diagram of a method for preventing the receipt of unauthorized messages at the receiving device, in accordance with another embodiment of the invention. When the receiving module 510 at the receiving device 105 receives a message from a sending device, for example sending device 100, step 605, the extracting module 515 extracts the identifier from the message, step 610. The message is validated before the message is actually delivered to the user inbox. In another embodiment, the user can manually ask for the message to be verified with the central sever. Now, the transmitting module 520 sends the extracted identifier to the central server 110 for validation, step 615.

In one embodiment of the invention, the transceiver 115 of the central server 110 receives the identifier from the transmitting module 520 of the receiving device 105. The comparing module 125 at the central server 110 compares the identifier with the identifier copy received from the transmitting module 215 of the sending device 100 earlier, step 620. The identifier copy that was sent to the central device 110 from the sending device 100 is stored on the central device 110 for validation at this stage to check the veracity of the message. If the central device 110 is unable to match the identifier copy received from the sending device 100 with the identifier received from the receiving device 105, both identifier and identifier copy pertaining to the same message, the central device 110 determines the message as an unauthorized message and informs the receiving device of the failure. Those skilled in the art shall realize that the central server 110 stores a list of identifier copies associated with the authorized messages sent from different sending devices. When the identifier matches the corresponding identifier copy stored in the list, a positive response is sent to the receiving device 105 for permitting the transmission of the message directly to the inbox of the user. In another embodiment, the message can also be scanned using a Bayesian filter 505 if the identifier does not match with one of the identifier copies stored at the central server 110.

The various embodiments of the invention provide a method and system for preventing an unauthorized message. An unauthorized message can be at least one of a spam message, an automated message, a computer virus and a trojan horse. The simple system and method require minimal system resources while still retaining the effectiveness to prevent distribution of unauthorized messages. For example, a technique which uses a combination of a CAPTCHA and embedding a unique identifier in the message is used to fight one of the most prevalent problems of the Internet. The transmission of the unauthorized message is prevented at the origin point itself instead of performing resource intensive filtering and other control steps generally used in the art. To further validate the authenticity of the message, an identifier that functions as a stamp of legitimacy is used. Insertion of the identifier helps in distinguishing the authorized messages from the undesired messages. As a result, the amount of processing required for verifying the authenticity of the message is reduced drastically.

Another advantage of the present system is the control in the spread of computer viruses. As the system does not permit messages to be transmitted without an authentication of the sender being a human, spreading of viruses is prevented effectively. Further, in one embodiment of the invention, the identifier attached to the message is also verified at the central server to provide additional authentication. Those skilled in the art will realize that the above recognized advantages and other advantages described herein are merely exemplary and are not meant to be a complete rendering of all of the advantages of the various embodiments of the present invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for preventing an unauthorized message, the method comprising:
determining if a message is composed manually or by an automated agent;
inserting an identifier in the message in response to determining if the message is composed manually or by an automated agent;
transmitting an identifier copy associated with the message to a central server, the identifier copy being substantially similar to the identifier; and
sending the message to a receiving device.

2. The method of claim 1, wherein the determining step comprises
displaying a query to a user sending the message; and
receiving a response to the query from the user.

3. The method of claim 1, wherein the identifier and the identifier copy are numerical identifiers.

4. The method of claim 1, further comprises:
receiving the message at the receiving device;
extracting the identifier from the message;
sending the identifier to the central server;
comparing the identifier with the identifier copy stored at the central server; and
sending a response to the receiving device in response to comparing the identifier with the identifier copy stored at the central server.

5. The method of claim 1 wherein the unauthorized message is at least one of a computer virus and a trojan horse.

6. A method for preventing an unauthorized message, the method comprising:
determining if a message is composed manually or by an automated agent;
inserting an identifier in the message in response to determining if the message is composed manually or by an automated agent;
transmitting an identifier copy associated with the message to a central server, the identifier copy being substantially similar to the identifier;
sending the message to a receiving device;
receiving the message at the receiving device;
extracting the identifier from the message;
sending the identifier to the central server;
comparing the identifier with the identifier copy stored at the central server; and
sending a response to the receiving device in response to comparing the identifier with the identifier copy stored at the central server.

7. The method of claim 6, wherein the determining step comprises
displaying a query to a user sending the message; and
receiving a response to the query from the user.

8. The method of claim 6, further comprising filtering the message using a Bayesian filter if the identifier does not match the identifier copy stored at the central server.

9. A system for preventing an unauthorized message, the system comprising:
a sending device, the sending device comprising:
a determining module for determining if a message is composed manually or by an automated agent;
an insertion module for inserting an identifier in the message in response to determining if the message is composed manually or by an automated agent;
a transmitting module for transmitting the message to a receiving device, the transmitting module transmitting an identifier copy associated with the message to a central server, the identifier copy being substantially similar to the identifier;
a receiving device, the receiving device comprising:
a receiving module for receiving the message;
an extracting module for extracting the identifier from the message;
a transmitting module for transmitting the identifier to the central server;
wherein the central server comprises a comparing module for comparing the identifier with the identifier copy stored at the central server and sending a response to the receiving device based on the comparison.

10. the system of claim 9, wherein the receiving module, extracting module and transmitting module at the receiving device can be integrated within a single module.

11. The system of claim 9, wherein the determining module, insertion module and transmitting module at the sending device can be integrated within a single module.

12. The system of claim 9, wherein the message can be filtered using a Bayesian filter at the receiving device if the identifier does not match the identifier copy stored at the central server.

13. The system of claim 9, wherein the sending device and the receiving device can be at least one of a laptop, personal digital assistant, personal computer or a mobile device.

14. The system of claim 9, wherein the message is at least one of an electronic mail, an audio file, a video file, a image file and a multimedia message.

15. The system of claim 9, wherein the identifier and the identifier copy are numerical identifiers.

16. A central device in communication with a sending device and a receiving device, the central device configured for preventing an unauthorized message comprising:
a transceiver; and
a processor, the transceiver adaptively coupled with the processor and adapted for:
obtaining an identifier copy associated with a message from the sending device;
receiving an identifier from the receiving device, the identifier being extracted from the message at the receiving device;
comparing the identifier with the identifier-copy; and
sending a response to the receiving device based on the comparison.

17. The central device of claim 16, wherein the identifier is inserted in the message at the sending device in response to determining if the message is composed manually or by an automated agent.

18. The central device of claim 16, wherein the identifier and the identifier copy are numerical identifiers.

19. The central device of claim 16 is a central server.
